(19) United States
(12) Patent Application Publication
(10) Pub. No.: US 2024/0191004 A1
(43) Pub. Date: Jun. 13, 2024

(54) THREE-DIMENSIONAL NANOLITHOGRAPHY SYSTEMS AND METHODS

(71) Applicant: Purdue Research Foundation, West Lafayette, IN (US)

(72) Inventors: Liang Pan, West Lafayette, IN (US); Xianfan Xu, West Lafayette, IN (US); Bryan William Boudouris, West Lafayette, IN (US)

(73) Assignee: Purdue Research Foundation, West Lafayette, IN (US)

(21) Appl. No.: 18/539,218

(22) Filed: Dec. 13, 2023

Related U.S. Application Data
(60) Provisional application No. 63/432,364, filed on Dec. 13, 2022.

(51) Int. Cl. C08F 2/50; B29C 64/135; B29C 64/20; B33Y 10/00; B33Y 30/00; B33Y 70/00; C08F 222/10

(52) U.S. Cl. CPC C08F 2/50; B29C 64/135; B29C 64/20; B33Y 10/00; B33Y 30/00; B33Y 70/00; C08F 222/102; C08F 222/103; C08F 222/105; B29K 2105/0005

(57) ABSTRACT

A three-dimensional nanolithography system includes forming a photocurable resin including one or more organic monomers, a photoinitiator, and an inhibitor, defining a lithographical patterning region, directing a light beam toward the lithographical patterning region to initiate polymerization, and controlling an initiator depletion technique to reduce an undesired portion of the polymerization.

### CROSS-REFERENCE TO RELATED APPLICATIONS

This application is related to and claims the priority benefit of U.S. Provisional Patent Application No. 63/432,364, entitled “Three-Dimensional Nanolithography Systems and Methods,” filed Dec. 13, 2022, the contents of which are hereby incorporated by reference in their entirety into the present disclosure.

### GOVERNMENT SUPPORT CLAUSE

This invention was made with government support under CMMI 1634832 and CMMI 2229143 awarded by the National Science Foundation. The government has certain rights in the invention.

### TECHNICAL FIELD

The present application relates to additive manufacturing, and more particularly to formulations of resin compounds for high-speed nanolithography and methods of forming three-dimensional nanoscale objects therefrom.

### BACKGROUND

This section introduces aspects that may help facilitate a better understanding of the disclosure. Accordingly, these statements are to be read in this light and are not to be understood as admissions about what is or is not prior art.

Additive manufacturing uses data computer-aided-design (CAD) software or three-dimensional (3D) object scanners to direct hardware to deposit material, layer upon layer, in precise geometric shapes. As its name implies, additive manufacturing adds material to create an object. By contrast, when you create an object by traditional means, it is often necessary to remove material through milling, machining, carving, shaping or other means.

Additive manufacturing can pattern 3D parts for rapid prototyping and low-volume applications in many technological areas. It proliferates with a number of distinct technologies and is capable to build objects covering a wide range of materials and feature dimensions. Among different patterning technologies, photopolymerization is a common approach to create features at microscale in a light-sensitive resin bath. Because of its favorable process accuracy and flexibility, photopolymerization can create complicated 3D shapes by projection of dynamic optical field or fast scan of a focused laser beam.

Projection method features high printing throughout at microscale. In order to spatially define the region of polymerization, variety of approaches are developed to avoid undesired polymerization. Projection micro-stereolithographic (uSL) methods add inert photoabsorbers to limit the light penetration to create a writing zone only in the top-most layer of the bath and to sequentially create a layered 3D object by repeating dynamic two-dimensional (2D) patterning onto each layer of fresh resin. A mechanical recoating procedure is needed for forming a fresh resin layer before each projection. To avoid the slow-down by the recoating step, some applications use fluorinated oil as a mobile liquid interface to maintain a constant supply of fresh resin for continuous fabrication. To further improve the printing speed, the continuous liquid interface production (CLIP) can add a dead zone of polymerization above the writing zone which allows continuous refill of fresh resin without the need for a dedicated recoating step. One approach is to use a gas permeable window to create an oxygen-rich zone near the window by using oxygen inhibition in radical polymerization. Another approach is to photochemically generate inhibiting agents to define the dead zone by using a second light beam. In some applications, a reverse algorithm of CT imaging is used to spatially control the dosage of illumination and to create 3D parts using fast volumetric illuminations.

### SUMMARY

Aspects of this disclosure describe resin compounds and methods for high-speed 3D nanolithography using a one-photon nonlinear polymerization process. Specifically, in some embodiments, a method of forming nanoscale objects can include various steps such as forming a photocurable resin including one or more organic monomers, a photoinitiator, and an inhibitor, defining a lithographical patterning region, directing a light beam toward the lithographical patterning region to initiate polymerization, and controlling an initiator depletion technique to reduce an undesired portion of the polymerization. Controlling the initiator depletion technique can include gradually reducing the photoinitiator.

In some versions of the method, an additional step can include generating oxygen at the lithographical patterning region. The lithographical patterning region can include positioning first and second electrodes adjacent to the lithographical patterning region, and applying a voltage differential between the first and second electrodes while the light beam contacts the photocurable resin.

In other versions of the method, directing the light beam to the lithographical patterning region can include activating a 405-nanometer diode laser. In still some versions, the method can include adjusting a position of an objective lens relative to the photocurable resin, the objective lens including a numerical aperture of 1.4 and 100× magnification.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic diagram of two-step absorption;

FIG. 2 depicts a schematic diagram of a simplified focused laser path including a desired printing spot, or voxel;

FIG. 3A depicts a schematic diagram of one exemplary nanolithography system operable to form arbitrary 3D structures;

FIG. 3B depicts diagrams of exemplary photo initiators, monomers, and inhibitors for forming the resin of the nanolithography system of FIG. 3A;

FIG. 3C depicts a diagram of the working mechanism of inhibition of the resin of FIG. 3B, showing I as the photo initiator, M as the monomer, H as the inhibitor, R· as the radical, Q* as the dead polymer chain, and R(M)_m as the polymer;

FIG. 4A depicts a graphical representation of an output of an experiment controlling different writing power and scanning speeds and the linewidths obtained, showing an inhibition-induced nonlinear response;

FIG. 4B depicts an output SEM image of the written lines from the experiment of FIG. 4A, shown at a scale of 2 μm;

FIG. 5A depicts an output SEM image of a 2D pattern of the Purdue University “block P” logo, shown at a scale of 10 μm;

FIG. 5B depicts an output SEM image of a 2D pattern of a wire grid of 420 nm linewidth, shown at a scale of 2 μm;

FIG. 5C depicts an output SEM image of a 2D pattern of a single line of 130 nm linewidth;

FIG. 6 depicts various SEM images of woodpile structures, showing a top view labeled (a) at a scale of 10 μm, a magnified top view labeled (b), a 30° tilt side view labeled (c), and a magnified side view labeled (d);

FIG. 7 depicts various SEM images of different structures, showing the Purdue University “block P” logo on a tower at a scale of 10 μm labeled (a), a moai statue at a scale of 50 μm labeled (b), and a suspended line between structure labeled (c);

FIG. 8A depicts a schematic of one exemplary electrochemical oxygen generation system; and

FIG. 8B depicts output print results from the electrochemical oxygen generation system of FIG. 8A.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Lithographical scanning methods can write fine features at the sub-microscale. Two-photon lithography uses nonlinear excitation of photo-responsive materials to locally activate voxel-wise polymerization. Two-photon lithography commonly uses a femtosecond laser operating at the near infrared (IR) wavelength to scan the voxel inside the material to form 3D shapes. When using high numerical aperture (NA) objectives, two-photon lithography can reliably produce submicron-scale features beyond the diffraction limit although using longer wavelengths. Inspired by stimulated-emission depletion (STED), the writing voxel can be trimmed by another depletion light and can demonstrate nanoscale patterning at about 100 nanometers (nm). However, despite its high patterning resolution, two-photon lithography still presents a relatively high tooling cost and low throughput as compared to projection micro-stereolithography.

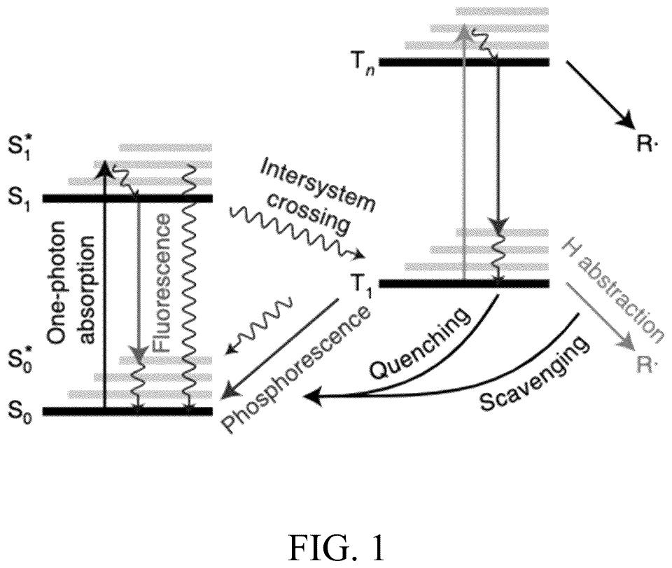

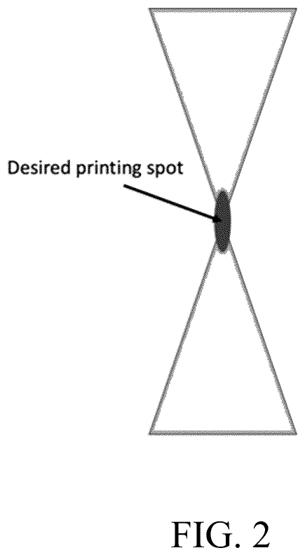

There is also a one-photon-polymerization side effect resulting from the ground triplet state of the photoinitiator regarding two-step absorption, where the undesired photochemical reaction caused by the ground triplet state of the photoinitiator can accumulate into polymerization after a long time of printing. As shown in FIG. 1, the T₁ state, indicating the ground triplet state of the photoinitiator, is a key cause for unwanted one-photon-polymerization. A radical comes out of the ground triplet state of the initiator through a process called hydrogen-atom abstraction. The unwanted one-photon polymerization happens throughout the entire region shown in FIG. 2. A two-step absorption, however, dominates in the desired printing spot called the voxel. FIG. 2 depicts the laser profile near the voxel (i.e., x the desired printing spot). One potential issue is the accumulated radicals in the lighter shaded regions surrounding the voxel. Multiple exposures cause the accumulated radicals near the voxel, including the lighter areas and two tails of the centrally located voxel. Those unwanted radicals accumulate as the overall exposure time increases, reducing the resolution of the printing results.

Accordingly, the unwanted polymerization may be suppressed by controlling the initiator depletion technique. The relative concentration of the initiating and inhibiting components may be adjusted to the point where no polymerization can occur at low light intensity with long exposure duration. This may be achieved by gradually reducing the initiator and studying the writing responses at different light intensity levels. At a certain level, high intensity writing still has satisfactory performance but low intensity writing is restricted or eliminated.

Recent research has studied the use of the spatial-temporal focusing effect to perform multiphoton projection to enhance the process throughput and to successfully build millimeter-sized 3D parts with sub-micron features. Continuous-wave (CW) lasers may also be used to reduce the tool cost. By allowing dissolved oxygen to refill around a weak writing voxel, 3D nanostructures can successfully be written at a linear speed of 10 μm (micrometers) per second (μm/s). Photo-induced radicals could also be used to produce the inhibition effect near the voxel. Other one-photon induced nonlinear effects can also be used, such as thermal initiations, to locally activate polymerization at the voxels. To that end, described below are improvements to nanolithography. Particularly, described is a high-speed 3D nanolithography system and method using a one-photon nonlinear polymerization process. By controlling multiple competing processes, such as the activation and transport of initiating and inhibiting radicals, patterning of the nanoscale features can be achieved at scanning speeds of 100s to 1000s of μm/s using a milliwatt level CW laser.

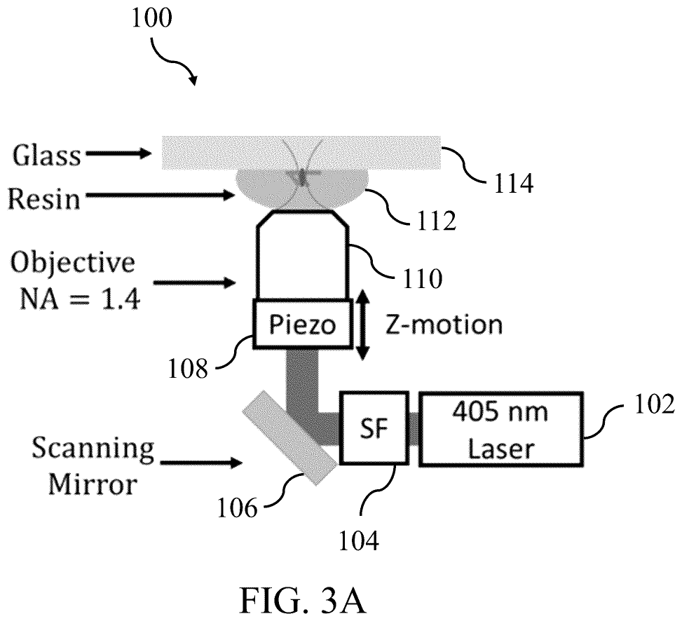

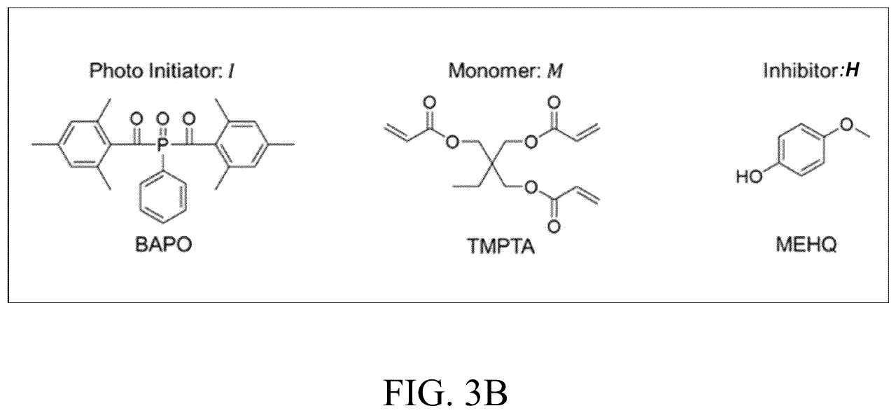

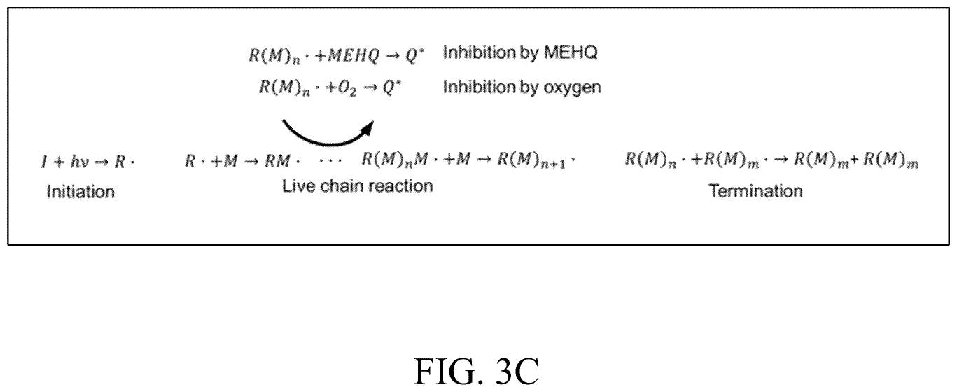

One example nanolithography system (100) is constructed as illustrated in FIG. 3A. A CW diode laser (102) is selected, and a spatial filter (104) or aperture is integrated with the laser to refine the beam quality. In some embodiments, the laser (102) is operated at a 405-nanometer wavelength, although it should be understood that variations in the wavelength would achieve positive results in certain applications. To scan the beam laterally, the laser is steered by a piezo scanning mirror (106) to provide the in-plan 2D motions, and an objective z-piezo (108) is mounted under an objective lens (110) to actuate the focal plane in the z-direction and therefore a 3D patterning space can be accessed. Particularly, the objective lens (110) can be mounted on the z-piezo (108), and a drop of resin (or “photoresist”) (112) can be placed between the objective lens (110) and a cover slide (114) to conduct the patterning experiments. Accordingly, the objective lens (110) can include a numerical aperture of 1.4 and 100× magnification and can be mounted on the z-piezo (108). The beam of the laser (102) passes through the scanning mirror (106), the objective lens (110), and the voxel is formed inside the resin (112).

In one example, the laser (102) used can be a 405-nm continuous wavelength single-mode diode laser, such as the L405P150 manufactured by Thorlabs, Inc. of Newton, New Jersey. The scanning mirror (106) can be adjusted to control the laser focal spot position in the focal plane, which can control the laser focal spot at 1000 μm·s-1 for a 100× objective lens. In some versions, the scanning mirror (106) may be a P-721 manufactured by PI (Physik Instrumente) L.P. of Auburn, MA and can be used for the z-positioning of the laser focal point. Additionally, the cover slide (114) can be made of glass or any other suitable material providing the same function.

The spatial filter (104) can be a 910A spatial filter manufactured by Newport Corporation of Irvine, CA. The piezo scanning mirror (106) can be, for example, a S-330 Fast Piezo Tip/Tilt Platform manufactured by PI (Physik Instrumente) L.P. of Auburn, MA. The z-piezo can be, for example, a P-725 High Dynamics Piezo Scanner manufactured by PI (Physik Instrumente) L.P. of Auburn, MA. Still further, the objective lens (110) can be, for example, a CFI Plan Apo No Cover Glass (NCG) objective lens manufactured by Nikon Corporation of Tokyo, JP to focus the laser from the source with a working distance of 160 μm. While certain specific examples of components have been described above, it should be understood that those are merely one example system and any one or more components may be substituted as needed without deviating from the general system (100) described.

The photocurable resin (112) includes monomers, photoinitiators, inhibitors/quenchers, and other additives. The composition of the resin mixture is held close to the condition of photoinitiator depletion such that, under low-intensity but prolonged light excitation, the photoinitiator can be gradually consumed by inhibitors/quenchers before any local polymerization can occur, however, an intensity higher than a certain threshold value can still trigger local polymerization. The monomer can be a single kind (e.g., Pentaerythritol triacrylate (PETA)) or a mixture of multiple kinds of monomers (e.g., a mixture of trimethylolpropane triacrylate (TMPTA) and Triethylene glycol dimethacrylate (TEGDMA)). The photoinitiators can be a single kind of photosensitive chemical (e.g., Phenylbis (2,4,6-trimethylbenzoyl)phosphine oxide (BAPO)) or a mixture of multiple kinds (e.g., a mixture of camphorquinone (CQ) and phenylpropanedione (PPD)). The additives are the materials that don't directly participate in the photoinitiation and polymerization reactions. Examples of such materials include photoabsorbers (e.g., Sudan I), nanoparticles (e.g., alumina and silica nanoparticles), non-photosensitive solvents (e.g., water), and other reactive chemicals (e.g., KOH for electrolysis, Zinc tetraphenylporphyrin (ZnTPP) for regulating inhibitor concentration).

Shown in FIG. 3B is one specific example of the resin (112) in which microstructures are directly written, which can be formed using the following components: a mix of organic monomers trimethylolpropane triacrylate (TMPTA) and Triethylene glycol dimethacrylate (TEGDMA), Phenylbis (2,4,6-trimethylbenzoyl)phosphine oxide (BAPO) as the photoinitiator, of 4-Methoxyphenol (MEHQ) as the inhibitor and Sudan I as the photoabsorber. In some particular embodiments, the resin (112) can be formed using TMPTA and 5 wt % of TEGDMA, 0.008 wt % of BAPO, 0.3 wt % of MEHQ, and 0.1 wt % of Sudan I. The photoinitiator BAPO can be used in low concentration and may be diluted before being mixed with other components. In some embodiments, the remainder of the materials can be measured, mixed, and sonicated for two hours and stored in a vial under room temperature with minimum exposure of ambient light. It should be understood that, while specific component concentrations are provided, some nanolithography applications may nevertheless function successfully according to the systems, methods, and descriptions herein using resins (112) with slight variations in one or more of the component concentrations.

To achieve a highly nonlinear response, the concentrations and components of the photocurable resin can be adapted based on the free radical polymerization mechanism as shown in FIG. 3C. When the initiator molecules (I) in the resin absorb photon energy (hν) from the laser, these molecules would be excited and generate initiating radicals (R·). These initiating radicals later activate the monomers (M) and launch live chain reaction to increase the molecular weight and form the polymer. Typically, in this free radical polymerization process, the conversion rate of the monomers is determined by the accumulative amount of photon absorbed, disregarding the intensity and exposure time of the light, which yields a linear process. The dissolved oxygen usually has a much lower concentration than the photoinitiator and provides negligible inhibition effects in the polymerization process when excitation light is intense. However, the photoinitiator is formed to have a low concentration similar to that of the dissolved oxygen, thus a highly nonlinear response arises due to several competing effects including initiation, inhibition, depletion, and diffusion. At the onset of polymerization at the voxel location, radicals initiated outside the voxel would be strongly inhibited to prevent undesired polymerization. Meanwhile, inside the voxel, initiation radicals are quickly generated by the intense light and promptly deplete oxygen locally and take over the inhibition effect. In addition, the photoabsorber in the resin can also absorb the light and locally increase the temperature to accelerate the crosslinking rate within the voxel.

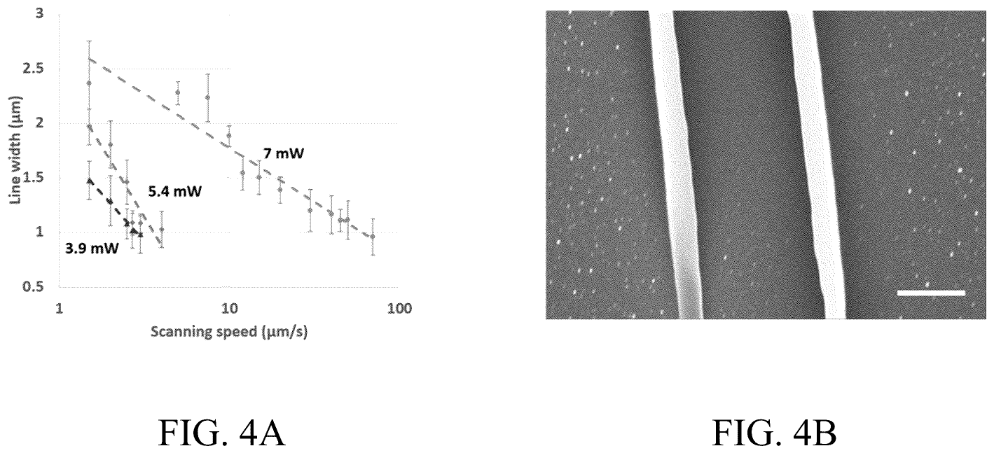

To determine the effective nonlinearity induced by inhibition of the resin described above, an experiment varying different speed and power was performed, and the resulting linewidth as shown in FIG. 4B is recorded to show the nonlinearity results of FIG. 4A. The results show that the polymerization can barely occur with low power and high scanning speed, but the polymerization increases significantly as the power is increased merely 38% and 79% compared to common one photon polymerization where the conversion is linear to the power-exposure time integration. This process shows that the nonlinearity of intensity and demonstrates that oxygen and MEHQ scavenge the initiating radicals and stop the polymerization when low intensity is applied. This process further shows that a higher amount of the initiating radicals generated by high intensity can deplete the oxygen and MEHQ before the diffusion-driven, therefore refilling and activating the polymerization. Based on the highly nonlinear response of intensity, the writing voxel is confined in the 3D space as proposed, and hence arbitrary 3D printing is achieved.

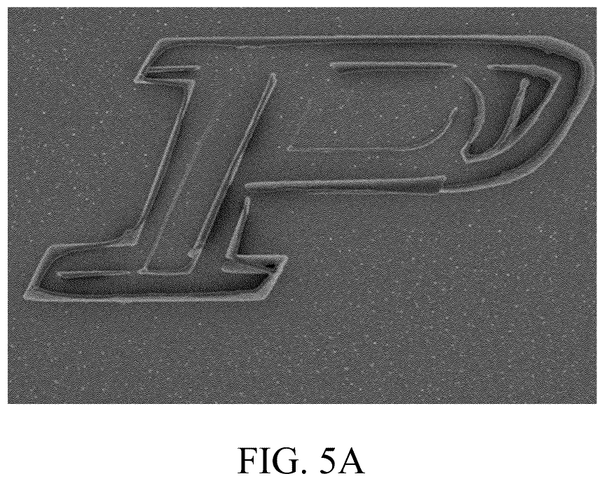

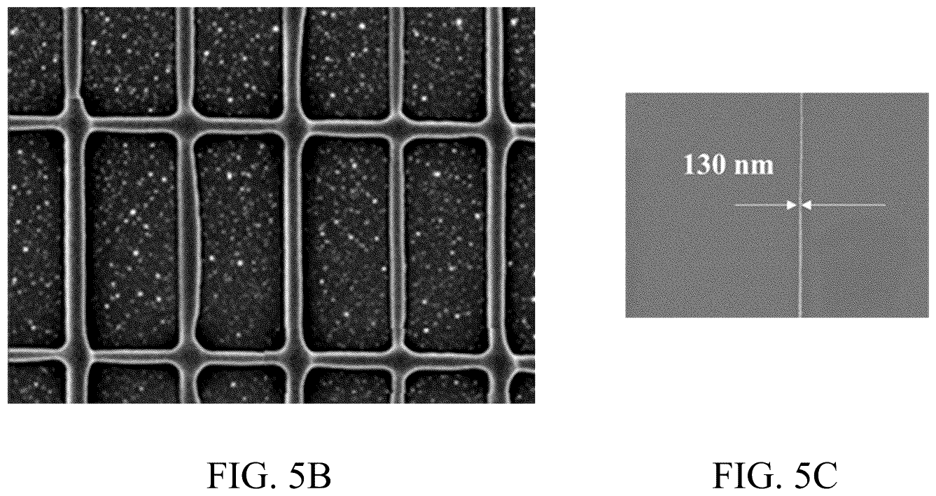

After verifying the intensity nonlinear response of the resin, the first set of experiments described write simple planar structures on glass substrates to further investigate the quality of the writing. First, by focusing the laser on the substrate, a 2D Purdue University “block P” logo is fabricated as shown in FIG. 5A. This demonstrates the method can fabricate arbitrary 2D patterns with resolution of 1 μm in width and 2 μm in height, which can be quantified by the tilted part of the line. Since the scanning speed is not always consistent when making turns, these corners show a thicker feature size of 2 μm due to polymerization accumulation. Second, a 2D grid is shown in FIG. 5B. Since the scanning speed is consistent, a more uniform linewidth of 420 nm can be measured. Because of the polarization direction of the laser, the focus is tighter in vertical direction, causing the vertical linewidth of 350 nm, 40% thinner than the horizontal linewidth. To minimize the polymerization accumulation and investigate the best feature size, a single stroke writing line is shown as FIG. 5C. Since the writing is starting in an inhibition-rich condition, the polymerization can only start when the balance of initiation and inhibition just reach, resulting a minimum linewidth of 130 nm, which is close the optical diffraction limit of the experimental setup.

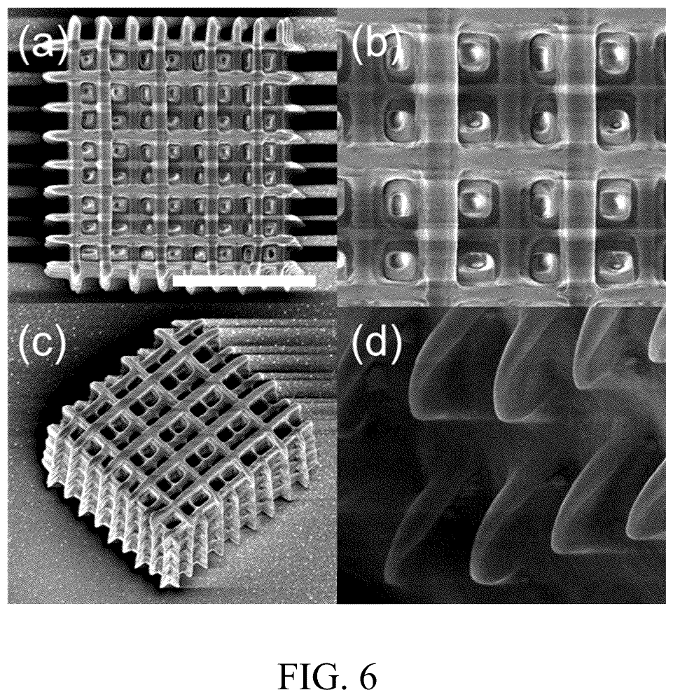

Woodpile and other arbitrary structures are fabricated, as shown in FIG. 6, to demonstrate the performance of the resin. As more understanding of inhibition and polymerization accumulation, temporal modulation is integrated to enhance the nonlinearity. By changing the laser from CW mode to pulse mode of 10s to 100s kHz, the radical diffusion and reaction time is limited and allows oxygen refilling, and therefore finer 3D structures are written with minimized polymerization accumulation. As shown in FIG. 6, structures labeled (a) and (b), the lower layers of the woodpile structure can be clearly observed with lateral linewidth of 1 μm, indicating reduced polymerization accumulation. Also, the detail features on the side show well-defined layers when fabricating 3D structures in FIG. 6, structures labeled (c) and (d).

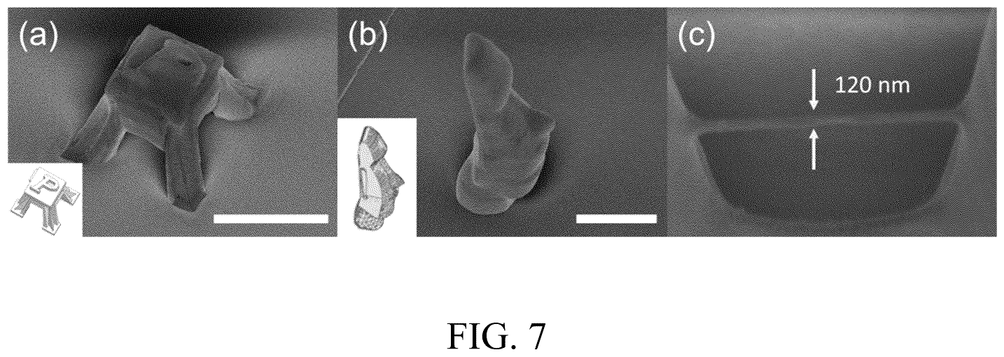

Finally, this experiment depicts some more complex structures, shown in FIG. 7. A printed tower with the Purdue University “block P” logo is shown labeled (a), having a hollow base with ridges on legs. A Moai structure of height of 80 μm is printed and shown labeled (b), which demonstrates a high aspect ratio fabrication of the system. A single suspended line with width of 120 nm is characterized and showed labeled (c), demonstrating the accessibility of nano-scale feature sizes in 3D printing. These results of FIG. 7 overall demonstrate the capability of the proposed methods as well as the potential for a versatile quantity of applications.

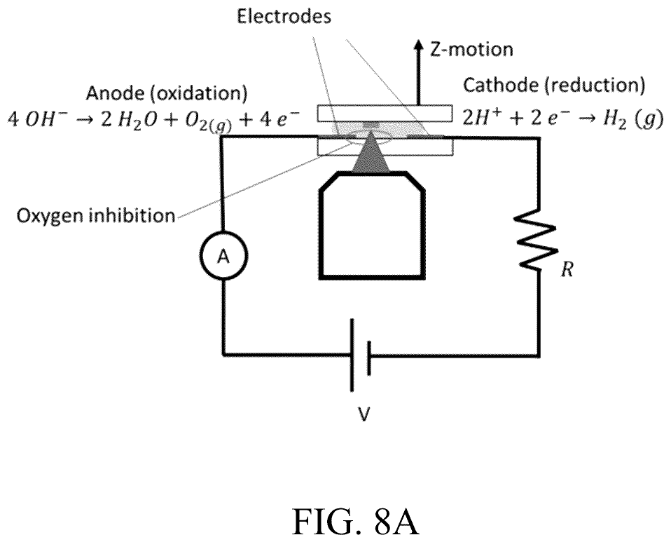

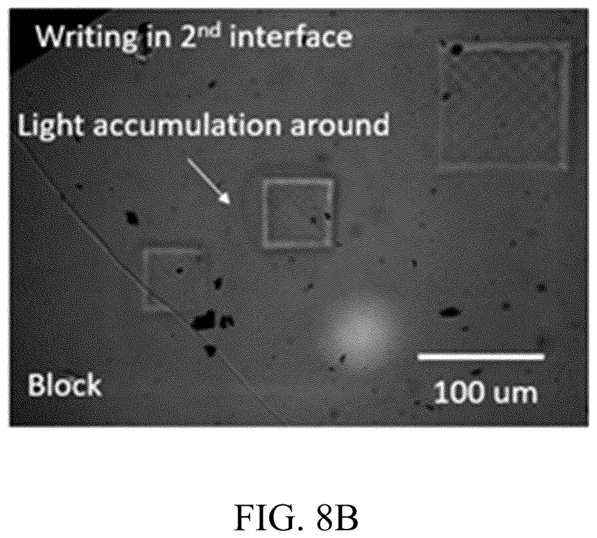

Since the oxygen refilling can be limited by the diffusion, oxygen inhibition methods can be limited by the rate of oxygen diffusion. To overcome this problem, a different way of directly triggering oxygen generation near the patterning region is described herein. When applying an electrical voltage, molecules (e.g., water) can decompose and release oxygen molecules. FIG. 8A shows an electrical system for oxygen molecule generation. A 10 wt % of water solution with 0.5M of potassium hydroxide (KOH) as electrolyte is added into a poly(ethylene glycol) diacrylate (PEGDA)-based resin, which is a water-soluble resin. This resin is used in direct laser writing experiments. After applying an external voltage, the system would evolve oxygen in the anode and hydrogen in the cathode. By proper design of the location of the electrodes, oxygen can be generated near the patterning area to inhibit unwanted polymerization. With this approach, an anode array can be fabricated beneath the writing area and actively create a dead zone to realize continuous liquid interface production (CLIP). FIG. 8B illustrates the printing results from one example experiment utilizing the system of FIG. 8A.

As an alternative, a photocatalytic method can be utilized. Instead of applying an external voltage, the driving electric potential can be generated by photons, where the patterning light beam or another light beam can be used to selectively trigger oxygen generation. In this approach, the electrodes are replaced by photocatalytic materials such as titanium dioxide (TiO₂). TiO₂ is a semiconductor with bandgap of approximately 3.2 eV. When TiO₂ absorbs UV light, its bandgap would use the energy to split electrons and holes inside the material. The electrons and holes would diffuse to interact with the resin at the surface, and transfer charge to generate oxygen.

As another alternative method, light rays may be utilized to directly generate oxygen, such as light-induced decomposition of hydrogen peroxides to release oxygen molecules.

In conclusion, a 3D nanolithography system based on one-photon, two-step nonlinear polymerization has been described. In some embodiments, the system utilizes a 405-nm diode laser. By balancing the initiation and the inhibition, a nonlinear intensity-response polymerization can be achieved. The polymerization voxel is excited by the focused laser beam, therefore exciting the photoinitiation locally with the assistance of a photo absorber. Further, oxygen and MEHQ inhibit the initiating radicals far from the focus to confine a writing voxel in the writing space. Compared to multiphoton lithography, this method utilizes diode lasers which are less expensive and it allows parallel operations to further improve the performance. To further improve the work, higher NA and wavelength below 400 nm light can be implemented. Another approach considered is to utilize this described system and method and reduce the writing threshold to increase the throughput.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. A method of forming nanoscale objects, comprising:
(a) forming a photocurable resin including one or more organic monomers, a photoinitiator, and an inhibitor;
(b) defining a lithographical patterning region;
(c) directing a light beam toward the lithographical patterning region to initiate polymerization; and
(d) controlling an initiator depletion technique to reduce an undesired portion of the polymerization.

2. The method of claim 1, wherein controlling the initiator depletion technique includes gradually reducing the photoinitiator.

3. The method of claim 1, generating oxygen at the lithographical patterning region.

4. The method of claim 1, wherein generating oxygen at the lithographical patterning region includes:
(a) positioning first and second electrodes adjacent to the lithographical patterning region; and
(b) applying a voltage differential between the first and second electrodes while the light beam contacts the photocurable resin.

5. The method of claim 1, wherein the directing the light beam to the lithographical patterning region includes activating a 405-nanometer diode laser.

6. The method of claim 1, comprising adjusting a position of an objective lens relative to the photocurable resin, wherein the objective lens includes a numerical aperture of 1.4 and 100× magnification.

7. The photocurable resin of claim 1, comprising forming the one or more organic monomers to include trimethylolpropane triacrylate (TMPTA) and Triethylene glycol dimethacrylate (TEGDMA).

8. The photocurable resin of claim 7, comprising forming the TEGDMA content to 5 wt %.

9. The photocurable resin of claim 1, comprising forming the photoinitiator to include Phenylbis (2,4,6-trimethylbenzoyl)phosphine oxide (BAPO).

10. The photocurable resin of claim 9, comprising diluting the BAPO before mixing it with any other component of the photocurable resin.

11. The photocurable resin of claim 9, comprising forming the BAPO content to 0.008 wt %.

12. The photocurable resin of claim 1, comprising forming the inhibitor to include 4-Methoxyphenol (MEHQ)

13. The photocurable resin of claim 12, comprising forming the MEHQ content to 0.3 wt %.

14. The method of claim 1, comprising forming the photocurable resin to include a photoabsorber.

15. The photocurable resin of claim 14, comprising forming the photoabsorber to include Sudan I.

16. The photocurable resin of claim 15, comprising forming the Sudan I content to 0.1 wt %.

17. The photocurable resin of claim 1, comprising forming the photocurable resin to include 10 wt % of a water solution including potassium hydroxide (KOH).

18. A method of generating three-dimensional nanoscale objects in a lithographical patterning area, comprising:
(a) forming a photocurable resin including one or more organic monomers, a photoinitiator, and an inhibitor;
(b) directing a light beam toward the lithographical patterning area to initiate polymerization; and
(c) controlling an initiator depletion technique to reduce an undesired portion of the polymerization, wherein controlling the initiator depletion technique includes gradually reducing the photoinitiator.

19. The method of claim 18, generating oxygen at the lithographical patterning region.

20. The method of claim 18, wherein generating oxygen at the lithographical patterning region includes:
(a) positioning first and second electrodes adjacent to the lithographical patterning region; and
(b) applying a voltage differential between the first and second electrodes while the light beam contacts the photocurable resin.
